(19) United States
(12) Patent Application Publication
(10) Pub. No.: US 2006/0292269 A1
(43) Pub. Date: Dec. 28, 2006

(54) Meat quality-improving agent

(76) Inventors: Kenichi Yamada, Soka-shi (JP); Ryuichi Yoshikawa, Soka-shi (JP); Yusuke Nakanishi, Soka-shi (JP); Yuji Okura, Chuo-ku (JP)

Correspondence Address: WENDEROTH, LIND & PONACK, L.L.P., 2033 K STREET N. W., SUITE 800, WASHINGTON, DC, 20006-1021, US

(21) Appl. No.: 11/474,439

(22) Filed: Jun. 26, 2006

(30) Foreign Application Priority Data
Jun. 28, 2005 (JP) 2005-188578

(51) Int. Cl. A23B 7/148

(52) U.S. Cl. 426/106

(57) ABSTRACT

The present invention aims at providing, in a retort pouch food containing a meat alone, or together with other food materials, a meat quality-improving agent, which is added to a raw material meat, in order to inhibit deterioration in the texture of meat subjected to retort sterilization, and a meat quality-improving agent which comprises oil-processed starch containing oil and glycerol organic acid fatty acid esters; and a curdlan powder with an average particle size of 0.05 to 50 μm.

### BACKGROUND OF THE INVENTION

1. Field of the Invention

The present invention relates to a meat-quality improving agent, which inhibits texture deterioration in meats caused with heat and pressure sterilization (hereinafter referred to as retort sterilization).

2. Dsecription of Related Art

A retort pouch food is produced by filling cooked food in an airtight packaging container (retort pouch), sealing it, and subjecting it to retort sterilization. Today, various retort pouch foods such as curry, stew, pasta sauce, soup and ingredients served on rice in bowl are on the market. The retort pouch foods are, however, produced by heating at a high temperature of not less than 100° C. under pressure, thus resulting in deterioration of the quality of the food in the pouch. In particular, as for meat such as beef or pork, denaturation of protein is caused with excessive heating, therefore, meat tissues constract and break down, whereby gravy comes out, which leads to, in many cases, hard and dry texture without succulentness.

In order to solve the above problem, some pre-treatment methods for meat are proposed. For example, JP Publication No. 6-315361 proposes a method for producing a meat-processed product for a pressed and heated food comprises the steps of: injecting an injection solution containing a heat-resistant gelling agent into cut or sliced raw meat whose outer fats have been removed, and heating the treated raw meat to gelatinize the injected gelling agent and remove fats from the raw meat; JP Publication No. 10-73 proposes a method for producing retort processed food of fish and animal meat, wherein a thermally coagulable β-1,3-glucan and trehalose and/or a sugar alcohol are added to a food raw material; JP Publication No. 4-40849 proposes a method for producing a meat-processed food comprising the steps of: cooking meat with heat, filling the cooked meat in a container such as can, sealing it, and sterilizing it with heat, wherein the pickle containing salt, a red algae extract and water is injected to the raw material meat before cooking with heat; and JP Publication No. 5-64567 proposes a method for retort treatment of meat comprising immersing the meat containing an undenatured protein in a solution of an animal protein and impregnating the meat with the animal protein, proceeding to subject the meat alone or, together with other food materials to retort treatment.

These techniques, however, can give only insufficient effects, and it is actually hard to say that the demands by the food industry are met.

### SUMMARY OF THE INVENTION

An object of the present invention is, in a retort pouch food filling meat alone or together with other food materials, to provide, a meat quality-improving agent, which is added to a raw material meat in order to inhibit texture deterioration in meats subjected to retort sterilization.

As a result of intensive studies to solve the above-mentioned problems by the present inventors, we have found that when raw material meat filled into a retort pouch food is previously treated with pickle dispersed oil-processed starch, which contains oil, and glycerol organic acid fatty acid esters; and curdlan powder with an average particle size of 0.05 to 50 μm, the texture of the meat can be remarkably inhibited from deterioration even after the meat is subjected to retort sterilization. We have completed the present invention based on above-mentioned findings.

That is, the present invention relates to:
(1) a meat quality-improving agent which comprises oil-processed starch containing oil and glycerol organic acid fatty acid esters; and curdlan powder having an average particle size of 0.05 to 50 μm; and
(2) the meat quality-improving agent of (1), wherein the glycerol organic acid fatty acid esters are diacetyltartaric and fatty acid esters of glycerol.

When raw material meat added with the meat quality-improving agent of the present invention is cooked, it is filled in a retort pouch and subjected to retort sterilization. Thus, the resulting meat of the retort pouch food has excellent texture even after the retort sterilization.

### DETAILED DESCRIPTION OF THE INVENTION

The oil-processed starch according to the present invention is preferably obtained by adding oil, and glycerol organic acid fatty acid esters to starch, stirring uniformly the mixture, and, if necessary, drying and aging it.

Examples of the raw material starch used in the oil-processed starch include corn starch, potato starch, wheat starch, rice starch, sweet potato starch, tapioca starch, mung bean starch, sago starch, pea starch, and processed starch such as esterified starch (e.g., starch acetate, etc.), etherified starch (e.g., hydroxypropyl starch, etc.), crosslinked starch (e.g., phosphate crosslinked starch, etc.), oxidized starch (e.g., dialdehyde starch, etc.), starch treated with an acid, starch treated with heat-moisture, and starch processed with two or more combinations of esterification, etherification, cross-linking, and the like. The starch may be used alone or in combination with two or more kinds thereof. Preferred is a phosphate crosslinked tapioca starch.

Any oil can be used to add to the starch in the present invention without any limitation so long as it is edible oils and fats. Examples of such oils and fats include, for example, vegetable oils and fats such as soybean oil, canola oil, cottonseed oil, safflower oil, sunflower oil, rice bran oil, corn oil, coconut oil, palm oil, palm kernel oil, kapok oil, peanut oil, olive oil, high oleic canola oil, high oleic safflower oil, high oleic corn oil and high oleic sunflower oil; animal oils and fats such as beef tallow, lard, fish oil and milk fat; oils and fats obtained by fractionation, hydrogenation or transesterification of vegetable or animal oils and fats; and medium chain triglyceride (MCT), and the like. Preferred are soybean salad oil, safflower oil, sunflower oil, corn salad oil, and the like. In addition, cereal flour containing a large amount of oil such as raw soybean flour may be used in place of all or a part of the above-mentioned edible oils and fats.

Examples of the glycerol organic acid fatty acid esters added to the starch include, for instance, acetic and fatty acid esters of glycerol, lactic and fatty acid esters of glycerol, citric and fatty acid esters of glycerol, succinic and fatty acid esters of glycerol, diacetyltartaric and fatty acid esters of the glycerol, and the like. These glycerol organic acid fatty acid esters may be used alone or in combination of at least two of them. Preferred is diacetyltartaric and fatty acid esters of glycerol. Any fatty acids derived from edible vegetable and animal oils and fats may be used as the fatty acid constituting the ester without particular limitations. Examples thereof are linear saturated or unsaturated fatty acids having 6 to 24, preferably from 16 to 18, carbon atoms.

The above-mentioned glycerol organic acid fatty acid esters (other name: organic acid monoglyceride) can be obtained usually by reacting a glycerol monofatty acid ester (other name: monoglyceride) with an organic acid or organic acid anhydride, or reacting glycerol with an organic acid and a fatty acid. The outline of method for producing glycerol diacetyltartaric acid fatty acid esters is as follows:

Glycerol monofatty acid ester is molten, and diacetyltartaric acid anhydride is added thereto, then the mixture is reacted at a temperature of about 120° C. for about 90 minutes. The ratio of the glycerol monofatty acid ester and diacetyltartaric acid anhydride is preferably from 1/1 to 1/2 in a molar ratio. In addition, the atmosphere in a reaction vessel is preferably substituted with an inert gas during the reaction for preventing the reaction product from coloring and smelling. The reaction product of the glycerol monofatty acid ester and diacetyltartaric acid anhydride contains diacetyltartaric acid and unreacted glycerin monofatty acid ester, and the like, in addition to glycerol diacetyltartaric acid fatty acid esters.

In the present invention, examples of the method for adding the oil and the glycerol organic acid fatty acid esters to the starch include, for example, a method in which the oil and the glycerol organic acid fatty acid esters are separately added to the starch; a method in which a mixture of the oil and the glycerol organic acid fatty acid esters (hereinafter referred to as “oil composition”) is added to the starch; and the like. Preferably, the oil and the glycerol organic acid fatty acid esters are mixed, the mixture is heated to about 50 to 90° C., and the obtained oil composition solution is added to the starch.

An amount of oil composition added to the starch is from about 0.003 to 10 parts by mass, preferably from about 0.05 to 5.0 parts by mass, more preferably from about 0.1 to 1.0 part by mass, based on 100 parts by mass of the starch. The ratio of the oil to the glycerol organic acid fatty acid esters (oil/glycerol organic acid fatty acid esters) in the oil composition is within the range of about 1/99 to 99/1 (w/w), preferably from about 60/40 to 20/80 (w/w).

A method for mixing the starch and the oil composition and drying the mixture is not particularly limited. For example, the oil composition solution is sprayed to starch with an equilibrium moisture content or starch having a moisture content of about 20 to 40% by mass, in a fluid state in a fluidized bed dryer, and the mixture is dried; the oil composition solution is added to a starch cake having a moisture content of about 50% by mass, they are mixed, then the mixture is dried in, for example, a shelf-type air dryer to give a powder; and the oil composition solution is added to a starch slurry having a moisture content of about 60 to 70% by mass, they are mixed, and then the mixture is dried in a spray dryer or a drum dryer to give a powder. Any methods may be used so long as the oil composition solution is adsorbed on the surface of starch in such a manner that the starch particles are not destructed.

The starch to which the oil composition is adsorbed is then aged. The aging may be carried out by extending the drying step as it is, but preferably treating at a higher temperature, because the treated starch can be aged in a relatively shorter period of time. The treated starch is usually aged under heating, for example in a temperature range of about 30 to 180° C., preferably about 30 to 140° C. in a shelf-type air dryer. When the treated starch is aged at not less than 120° C., it should be noted that the aging is carried out so as not to cause dextrinization of the starch. The time required for such aging depends on the adsorption amount of the oil composition to starch, the aging temperature, the aging device, the heat efficiency, and the like. For example, when about 0.1 part by mass of oil composition is added to 100 parts by mass of corn starch having a moisture content of about 35%, and they are mixed and dried at room temperature for about 20 hours, the treated starch may be aged at about 60° C. for about 5 hours, or at about 140° C. for about 1 hour.

After completion of the aging, the processed starch is conditioned to have a moisture content of preferably about 8 to 18% by mass, more preferably about 10 to 14% by mass, thereby to get the oil-processed starch used in the present invention.

The oil composition mentioned above may include an emulsifier for food such as glycerol fatty acid ester, sucrose fatty acid ester, sorbitan fatty acid ester, propylene glycol fatty acid ester and lecithin within the range where the objects of the present invention are not disturbed. The glycerol fatty acid ester may include glycerol acetic acid ester, polyglycerol fatty acid esters, and polyglycerol condensed ricinoleic acid esters, in addition to esters of glycerol and fatty acids. The lecithin includes a liquid lecithin containing an oil component, such as soybean lecithin and egg yolk lecithin; powdered lecithin obtained by removing oil from liquid lecithin, followed by drying; fractionated lecithin obtained by fractionating liquid lecithin and purifying it; and enzyme-decomposed or enzyme-treated lecithin obtained by treating lecithin with an enzyme; and the like. The oil composition may contain, if necessary, an antioxidant such as tocopherol, ascorbic acid palmitate, and tea extract.

The curdlan used in the present invention is thermally coagulable polysaccharides mainly comprising β-1,3-glucosidic linkage produced from a microorganism belonging to the genus Alcaligenes or Agrobacterium. Examples of the microorganism include, for instance, a mutant strain, NTK-u (IFO 13140) of Alcaligenese faccalis var. myxogenes strain 10C3K, Agrobacterium radiobacter (IFO 13127) and its mutant strain U-19 (IFO 13126), and the like.

The curdlan used in the present invention is commercially available, and any available products may be used without any particular limitation. Of these, curdlan powder with an average particle size of about 0.05 to 50 μm is preferably used. When curdlan with an average particle size of not less than 50 μm is used, it is preferable that the curdlan is finely ground using a known fine particle forming equipment such as an air-jet mill into an average particle size of about 0.05 to 50 μm. The curdlan with an average particle size of more than 50 μm disperses nonuniformly between muscle fibers of the meat.

One preferable embodiment of meat quality-improving agent of the present invention is a powder comprising about 16 to 99.9% by mass, preferably about 23 to 99.7% by mass, of the oil-processed starch, and about 0.1 to 84% by mass, preferably about 0.3 to 77% by mass of the curdlan, relative to 100% bymass of the quality improving agent. The oil-processed starch and the curdlan may be mixed by any methods known per se in the art without any particular limitations.

The meat used in the present invention is not particularly limited, and examples thereof include, for instance, beef, pork, chicken, horse meat, mutton, goat meat, domestic rabbit meat, poultry meat, fish meat, and combinations thereof. Of these, beef, pork and chicken are preferable. Usable meat parts are also not particularly limited and any parts may be used. Examples thereof include, for instance, shoulder loin, rib, rib loin, fillet, shoulder meat, round, and the like for beef; rib, loin, shoulder loin, shoulder meat, round, arm meat, and the like for pork; breast meat, thigh, wing, tenderloin, and the like for chicken.

The amount of the meat quality-improving agent to be added to meat in the present invention is preferably about 0.11 to 11 parts by mass, more preferably about 0.35 to 3.5 parts by mass, based on 100 parts by mass of a raw material meat.

Although there is no particular limitation on a method of adding a meat quality-improving agent of the present invention to the meat, it is preferable to use the meat quality-improving agent dispersed in the pickle. For example, there is preferably employed an injection method wherein the meat quality-improving agent is dispersed in water together with other components usually contained in pickle, such as salts, saccharides, polyphosphates, nitrite salts, animal and vegetable proteins, thickening and stabilizing agents, seasonings, and spices to give pickle, and the obtained pickle is injected into raw material meat with an injector in an amount of about 10 to 80 parts by mass based on 100 parts by mass of the raw material meat, and the components in the pickle are fully dispersed in the meat in a tumbler; or a wet salting method wherein a raw material meat is immersed in pickle so that the pickle is permeated into the meat.

The meat impregnated with the pickle containing the meat quality-improving agent is cooked by a method suitable for desired cuisine. Then, the cooked meat is filled in a retort pouch alone or in combination of other food materials and/or various seasonings, and it is subjected to retort sterilization to give a retort pouch food. The retort sterilization is carried out, for instance, at a temperature of about 110 to 130° C. for about 20 to 40 minutes, preferable at about 121 to 127° C. for about 30 minutes.

### EXAMPLES

The present invention is further described in detail by means of Examples and Test Examples. It goes without saying that the present invention is not limited to the following Examples and Test Examples.

Production of Phosphate-crosslinked Tapioca Starch

Sodium trimetaphosphate (2 kg) and sodium carbonate (3 kg) were dissolved in water (180 L), and tapioca starch (100 kg) was dispersed in the solution, and sodium carbonate was added thereto to adjust the pH to 10.2. After the mixture was reacted at 50° C. for 6 hours under stirring, the reaction mixture was diluted with water (500 L), and neutralized to pH 7.0 with a 5% by mass hydrochloric acid solution. Subsequently, by removing water, washing the starch with water and drying, tapioca starch crosslinked with phosphoric acid (100 kg) (Reference Example 1) was gotten.

Production of Oil-processed Starch (Prototype 1)

The oil composition containing safflower oil (50% by mass) and diacetyltartaric and stearic acid esters of glycerol (trade name: Poem W-10; available from Riken Vitamin Co., Ltd.) (50% by mass) was warmed at 60° C. and dissolved the two, and 0.5 part by mass of the composition was added to 100 parts by mass of the phosphate-crosslinked tapioca starch (Reference Example 1) having a moisture content of 12.5%. The mixture was stirred for 10 minutes in a high speed mixer (Lodige mixer-FM130D; available from Matsuzaka Giken Co., Ltd.). The obtained mixture was spread on a tray, which was dried in a shelf-type air dryer having a temperature of 60° C. until the moisture content of the mixture became about 12.0% by mass. The dried mixture was pulverized, and the obtained powder was packaged in a polyethylene bag, which was aged at 60° C. for two weeks to give oil-processed starch (Prototype 1).

Production of Oil-processed Starch (Prototype 2)

Oil-processed starch (Prototype 2) was obtained in the same manner as in the production of oil-processed starch (Prototype 1) except that succinic and stearic acid esters of glycerol (trade name: Poem B-10; available from Riken Vitamin Co., Ltd.) were used in stead of diacetyltartaric and stearic acid esters of glycerol.

Production of Oil-processed Starch (Prototype 3)

Oil-processed starch (Prototype 3) was obtained in the same manner as in the production of the oil-processed starch (Prototype 1) except that citric and oleic acid esters of glycerol (trade name: Poem K-37; available from Riken Vitamin Co., Ltd.) were used in stead of diacetyltartaric and stearic acid esters of glycerol.

Production of Finely Ground Curdlan

Curdlan (available from Takeda-Kirin Foods Corporation, average particle size: about 100 μm) (500 g) was finely ground in a jet mill for research and development (device name: Kurimoto Pocket Jet; available from Kurimoto, Ltd.) to give finely ground curdlan (400 g) having an average particle size of about 45 μm. The average particle size was determined by using a laser diffraction particle size analyzer (device name: Microtrac MT-3000; available from Nikkiso Co., Ltd.).

### Example 1

The oil-processed starch (Prototype 1, 2 or 3) (75 g) and finely ground curdlan (trade name: Curdlan NS; available from Takeda-Kirin Foods Corporation, average particle size: about 20 μm) (25 g) were put in a 1 L-volume polyethylene bag, and the bag filled sufficiently with air was closed and shaken to give a meat quality-improving agent (Inventive Product 1, 2 or 3).

### Example 2

The oil-processed starch (Prototype 1) (75 g) and finely ground curdlan (average particle size: about 45 μm) (25 g) were put in a 1 L-volume polyethylene bag, and the bag filled sufficiently with air was closed and shaken to give a meat quality-improving agent (Inventive Product 4).

### Comparative Example 1

The oil-processed starch (Prototype 1) (75 g) and curdlan (available from Takeda-Kirin Foods Corporation, average particle size: about 100 μm) (25 g) were put in a 1 L-volume polyethylene bag, and the bag filled sufficiently with air was closed and shaken to give a meat quality-improving agent (Comparative Product 1).

### Test Example 1

A retort beef curry was made and evaluated.

1. Production of a Retort Beef Curry

Experimental Plot 1

Salt (8.0 parts by mass), sugar (1.0 part by mass), sodium glutamate (1.5 parts by mass), sodium polyphosphate (1.8 parts by mass), egg white (trade name: Egg White Powder; available from Riken Vitamin Co., Ltd.) (1.1 parts by mass), dextrin (trade name: Pinedex #2; available from Matsutani Chemical Industry Co., Ltd.) (1.4 parts by mass), and the meat quality-improving agent (Inventive Product 1) (2.2 parts by mass) were dissolved in water (83.0 parts by mass) to give pickle.

The pickle (16.7 parts by mass) was injected into a round of beef (83.3 parts by mass), and the resulting round of beef was tumbled for 5 hours in a refrigerator (the inside temperature: 5° C.) using a tumbler (Type: Tumbler 100; available from Futaba Electric Industry).

The treated meat was cut into 25-mm cubes, which were boiled at 90° C. for 10 minutes. Carrot and potato were cut into 15 mm-cubes, which were boiled in boiling water for 5 minutes. The boiled beef (10 g), boiled carrot (8 g) and boiled potato (12 g) were filled in a retort pouch, and a curry sauce (180 g) which was made by stewing fried onion (10 g) and a commercial curry roux (25 g) in water (200 g) for about 30 minutes was poured into the pouch. Then the pouch was sealed and subjected to retort sterilization at 121° C. for 30 minutes to give a retort curry.

Experimental Plot 2

A retort curry was made in the same manner as in Experimental Plot 1 except that the meat quality-improving agent (Inventive Product 2) (2.2 parts by mass) was used instead of the meat quality-improving agent (Inventive Product 1) (2.2 parts by mass).

Experimental Plot 3

A retort curry was made in the same manner as in Experimental Plot 1 except that the meat quality-improving agent (Inventive Product 3) (2.2 parts by mass) was used instead of the meat quality-improving agent (Inventive Product 1) (2.2 parts by mass).

Control Plot

A retort curry was made in the same manner as in Experimental Plot 1 except for pickle containing no meat quality-improving agent was used.

Evaluation of Retort Curry

The retort curries obtained in Experimental Plots 1 to 3 and Control Plot were stored at room temperature for one week. The retort pouches were boiled in boiling water for 5 minutes, and opened to take the beed therefrom. The beef texture was evaluated by 10 panelist according to the following criteria shown in Table 1:

TABLE 1

| Evaluation items | Score | Criteria |
|---|---|---|
| Tenderness | 4 | Tender |
| | 3 | Slightly tender |
| | 2 | Slightly hard |
| | 1 | Hard |
| Succulentness | 4 | Extremely succulent |
| | 3 | Very succulent |
| | 2 | Weakly succulent |
| | 1 | None |
| Chewing feeling | 4 | Good |
| | 3 | A little good |
| | 2 | A little bad |
| | 1 | Bad |

The results are average of the total scores by 10 panelists. The symbols in Table 2 are as follows:
⊚: extremely good average value: not less than 3.5
∘: good average value: from 2.5 to 3.4
Δ: slightly bad average value: from 1.5 to 2.4
X: bad average value: not more than 1.4

The results are shown in Table 2.

TABLE 2

| | | | | Chewing |
|---|---|---|---|---|
| | Retort curry | Tenderness | Succulentness | feeling |
| Example | Test 1 | ⊚ | ⊚ | ⊚ |
| | Test 2 | ◯ | ⊚ | ⊚ |
| | Test 3 | ◯ | ⊚ | ⊚ |
| Control | Control Plot | X | X | X |

It was apparent from Table 2 that when the pickle containing the meat quality-improving agent of the present invention was injected into beef, the texture of the beef, particularly the succulentness and chewing feeling, after retort sterilization was extremely improved.

Test Example 2

Retort roast pork was made and evaluated.

1. Production of Retort Roast Pork

Experimental Plot 4

Salt (6.4 parts by mass), sugar (15.4 parts by mass), dark soy sauce (11.6 parts by mass), sake lees powder (trade name: Shukoh-no-Hana in Japanese; available from Riken Vitamin Co., Ltd.) (0.6 part by mass), pork-based sauce (trade name: Char Siu Paste; available from Riken Vitamin Co., Ltd.) (1.0 part by mass), sodium hydrogencarbonate (1.0 part by mass), egg white (trade name: Egg White Powder; available from Riken Vitamin Co., Ltd.) (0.6 part by mass), dextrin (trade name: Pinedex #2; available from Matsutani Chemical Industry Co., Ltd.) (0.7 part by mass), and the meat quality-improving agent (Inventive Product 1) (1.25 parts by mass) were dissolved in water (61.55 parts by mass) to give pickle.

The pickle (33.3 parts by mass) was injected into pork shoulder meat (66.7 parts by mass), and the resulting meat was tumbled for 3 hours in a refrigerator (the inside temperature: 5° C.) using a tumbler (Type: Tumbler 100; available from Futaba Electric Industry).

Then, the raw material meat was put in a fibrous casing with a folding diameter of about 13 cm, which was tied with a kite string, and the resulting meat was braised at about 70° C. for 40 minutes, then at about 80° C. for about 40 minutes, next at about 95° C. for about 40 minutes and finally at about 98° C. for about 90 minutes in a steam box, while gradually raising the temperature in the box. The roast pork cooked with heat was cooled in a refrigerator (the inside temperature: about 4° C.) and sliced into about 1 cm-thick slices (about 50 g). These three meat slices were packaged in a packaging material for retort pouch and sealed, which was subjected to retort sterilization at 121° C. for 30 minutes to give a roast pork as a retort pouch food.

Experimental Plot 5

A retort roast pork was made in the same manner as in Experimental Plot 4 except that the meat quality-improving agent (Inventive Product 4) (1.25 parts by mass) was used instead of the meat quality-improving agent (Inventive Product 1) (1.25 parts by mass) used in Experimental Plot 4.

Experimental Plot 6

A retort roast pork was made in the same manner as in Experimental Plot 4 except that the meat quality-improving agent (Comparative Product 1) (1.25 parts by mass) was used instead of the meat quality-improving agent (Inventive Product 1) (1.25 parts by mass) used in Experimental Plot 4.

Experimental Plot 7

A retort roast pork was made in the same manner as in Experimental Plot 4 except that the oil-processed starch (Prototype 1) (0.94 part by mass) was used instead of the meat quality-improving agent (Inventive Product 1) (1.25 parts by mass) used in Experimental Plot 4.

Experimental Plot 8

A retort roast pork was made in the same manner as in Experimental Plot 4 except that finely ground curdlan (curdlan NS; available from Takeda-Kirin Foods Corporation; average particle size: about 20 μm) (0.31 part by mass) was used instead of the meat quality-improving agent (Inventive Product 1) (1.25 parts by mass) used in Experimental Plot 4.

2. Evaluation of Retort Roast Pork

The retort roast porks obtained in Experimental Plots 4 to 8 were preserved at room temperature for one week. The retort pouches were boiled for 5 minutes and opened to take the roast pork from the pouch. The texture of the pork was evaluated by 10 panelists according to the following criteria shown in Table 3.

TABLE 3

| Evaluation items | Score | Criteria |
|---|---|---|
| Tenderness | 4 | Tender |
| | 3 | Slightly tender |
| | 2 | Slightly hard |
| | 1 | Hard |
| Succulentness | 4 | Extremely succulent |
| | 3 | Very succulent |
| | 2 | Not very succulent |
| | 1 | None |
| Chewing feeling | 4 | Good |
| | 3 | A little good |
| | 2 | A little bad |
| | 1 | Bad |

The results are averages of the total scores by 10 panelists. The symbol in Table 4 as follows:
⊚: extremely good average value: not less than 3.5
∘: good average value: from 2.5 to 3.4
Δ: slightly bad average value: from 1.5 to 2.4
X: bad average value: not more than 1.4

The results are shown in Table 4.

TABLE 4

| | Retort roast | | | Chewing |
|---|---|---|---|---|
| | pork | Tenderness | Succulentness | feeling |
| Example | Experimental | ⊚ | ⊚ | ⊚ |
| | Plot 4 | | | |
| | Experimental | ⊚ | ⊚ | ◯ |
| | Plot 5 | | | |
| Comparative | Experimental | ⊚ | ◯ | X |
| Example | Plot 6 | | | |
| | Experimental | ⊚ | ◯ | X |
| | Plot 7 | | | |
| | Experimental | X | Δ | ◯ |
| | Plot 8 | | | |

The comparison between Example (Experimental Plot 4) and Comparative Example (Experimental Plots 7 and 8) apparently shows that the effect obtained from the combination of the oil-processed starch and the finely ground curdlan is not additive effect but synergistic effect.

The meat quality-improving agents of the present invention are used for raw material meat of retort pouch foods such as curry, hashed-beaf, pasta sauce, mabo-tofu sauce, Japanese pilaf mix, donburi (meat and vegetables on rice) mix, stew, soup, Japanese soup (e.g. tonsil (miso-soup with poak)), pilaf, hamburg steak, meatball, roast pork, yakitori (grilledchicken), teriyaki chicken (fried with soy sauce), and the like.

What is claimed is:

1. A meat-quality improving agent which comprises oil-processed starch containing oil and glycerol organic acid fatty acid esters, and curdlan powder having an average particle size of 0.05 to 50 μm.

2. The meat-quality improving agent according to claim 1, wherein the glycerol organic acid fatty acid esters are diacetyltartaric and fatty acid esters of glycerol.
